(19) United States
(12) Patent Application Publication
(10) Pub. No.: US 2005/0174682 A1
(43) Pub. Date: Aug. 11, 2005

(54) Housing for hard disk drive having structure to reduce flutter of disk

(75) Inventor: Yong-chul Yoo, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 10/986,042

(22) Filed: Nov. 12, 2004

(30) Foreign Application Priority Data
Jan. 28, 2004 (KR) 2004-5307

(51) Int. Cl. G11B 17/02

(52) U.S. Cl. 360/97.01

(57) ABSTRACT

A housing for a hard disk drive including a data storage disk, a spindle motor to rotate the disk, and an actuator to move a read/write head to a desired position of the disk, the housing enclosing and protecting the disk, the spindle motor, and the actuator, and having a base member and a cover member, wherein the housing is provided with at least one through hole to record servo track information on the disk, and at least one plug is inserted into the corresponding at least one through hole to fill the hole.

### CROSS-REFERENCE TO RELATED APPLICATIONS

This application claims the priority of Korean Patent Application No. 2004-5307, filed on Jan. 28, 2004, in the Korean Intellectual Property Office, the disclosure of which is incorporated herein in its entirety by reference.

### BACKGROUND OF THE INVENTION

1. Field of the Invention

The present invention relates to a hard disk drive, and, more particularly, to a housing for a hard disk drive having a structure to reduce flutter of a disk.

2. Description of the Related Art

A hard disk drive reads data from and/or writes data on a disk by using a read/write head. During the reading and writing operations, the head is shifted to a desired position on the surface of the disk by an actuator, while flying over the recording surface of the spinning disk at a proper height.

FIG. 1 is an exploded perspective view illustrating one example of a conventional hard disk drive.

Referring to FIG. 1, the hard disk drive includes a base member 11, a spindle motor 30 mounted to the base member 11 to rotate a disk 20, and an actuator 40 to move a read/write head to read/write data from/to a desired position on the disk 20.

The spindle motor 30 is provided on the base member 11. The disk 20 is firmly secured to the spindle motor 30 by means of a clamp 32 and at least one clamping screw 33 thereby to be rotated with the spindle motor 30.

The actuator 40 includes a swing arm 42 rotatably coupled to a pivot bearing 41 provided on the base member 11, a suspension 43 provided on one end portion of the swing arm 42 to support and elastically bias a slider, on which the head is mounted, toward the surface of the disk 20, and a voice coil motor (VCM) 45 to rotate the swing arm 42. The voice coil motor 45 is controlled by a servo control system. The swing arm 42 is rotated in a direction according to the Fleming's left-hand rule by the interaction between an electric current input to a VCM coil and a magnetic field generated by magnets. Specifically, when the disk 20 starts spinning by turning the hard disk drive on, the voice coil motor 45 rotates the swing arm 42 in a counterclockwise direction to move the head to a desired position on a recording surface of the disk 20. When the disk 20 stops spinning by turning the hard disk drive off, the voice coil motor 45 rotates the swing arm 42 in a clockwise direction to move the head away from the disk 20.

A cover member 12 is coupled to the upper portion of the base member 11 by use of a plurality of screws 19. The disk 20, the spindle motor 30, and the actuator 40 are enclosed and protected by a housing 10 including the base member 11 and the cover member 12 coupled to each other.

In the hard disk drive configured as described above, servo track information is previously recorded on a surface of the disk 20 in order to allow the read/write head to quickly and correctly move to a desired position on the disk 20, which is referred to as a servo track write (STW). In order to carry out the servo track write process, the base member 11 is provided on a side wall thereof with a clock-head receiving hole 14. The servo track information is recorded on the disk 20 by inserting a clock head into the housing 10 through the clock-head receiving hole 14. In addition, the base member 11 is provided on a bottom plate of the base member 11 with a push-pin receiving hole 15 so that a push pin may be inserted into the housing 10 to control the pivot of the actuator 40 when the servo track information is recorded on the disk 20.

There is a problem in that air flow within the housing 10 is unstable due to the clock-head receiving hole 14 and the push-pin receiving hole 15 formed on the base member 11. Specifically, turbulence is produced at a portion of the base member 11 formed with the clock-head and push-pin receiving holes 14 and 15, and, as a result, air pressure is abruptly lowered.

FIGS. 2A and 2B illustrate simulation results of a speed of air flow within a conventional hard disk drive formed with a clock-head receiving hole 14 on a side wall of a base. FIGS. 3A and 3B illustrate simulation results of a distribution of air pressure within a conventional hard disk drive.

Referring to FIG. 2A, it would be understood that a speed of air flow in the clock-head receiving hole 14 positioned at an outer edge of the disk 20 is lower than that of the air flow at other portions of the disk 20. Furthermore, it would be understood from FIG. 2B that turbulence is produced in the clock-head receiving hole 14.

Referring to FIGS. 3A and 3B, it would be understood that the air pressure around the disk 20 is lowered at the clock-head receiving hole 14, depending upon variations of the speed of the air flow and a flow direction.

As such, the distribution of air pressure around the disk 20 is not uniform according to a circumference direction of the disk 20, which in turn causes the disk 20 to remarkably flutter. In particular, there is a problem in that since the clock-head receiving hole 14 formed on the side wall of the base member 11 is positioned at the outer edge of the disk 20, which is significantly influenced by the variation of the air pressure, the edge of the disk 20 is more fluttered due to the clock-head receiving hole 14.

### SUMMARY OF THE INVENTION

The present invention provides a housing for a hard disk drive having a structure to reduce flutter of a disk, in which a plug is inserted in a hole used in a servo track write operation to suppress production of turbulence around the disk and make pressure distribution uniform, thereby reducing the flutter of the disk.

Additional aspects and/or advantages of the invention will be set forth in part in the description which follows and, in part, will be obvious from the description, or may be learned by practice of the invention.

According to an aspect of the present invention, there is provided a housing for a hard disk drive, the hard disk drive including a data storage disk, a spindle motor to rotate the disk, and an actuator to move a read/write head to a desired position of the disk, the housing enclosing and protecting the disk, the spindle motor, and the actuator, the housing including a base member and a cover member, wherein the housing is provided with at least one through hole to record servo track information on the disk, and at least one plug is inserted into the corresponding at least one through hole to fill the hole.

The at least one through hole may include a clock-head receiving hole, through which a clock head is inserted to record the servo track information on the disk, and a push-pin receiving hole, through which a push pin is inserted to control a pivot of the actuator. In this case, the clock-head receiving hole may be formed on a side wall of the base member, and the push-pin receiving hole may be formed on a bottom plate of the base member.

A surface of the at least one plug facing an interior of the housing may be flush with a corresponding inner surface of the base.

The at least one through hole may be formed in a taper shape of which a cross-sectional area may be gradually increased approaching an outside of the base member, and the at least one plug may be formed in a taper shape corresponding to that of the corresponding at least one through hole.

The at least one plug may be provided with a flange on an outer end portion thereof. In this case, an outer surface of the housing may be formed with a stepped portion around the at least one through hole to receive the flange of the corresponding at least one plug. Also, the at least one plug may be coupled to the housing with at least one screw.

The at least one plug may be adhered to the housing with an adhesive.

The at least one plug may comprise a plastic injection molding, and a sealing tape to shield an electromagnetic wave may be adhered to an outer surface of the housing to cover the plug. In this case, the sealing tape by be an aluminum tape.

The at least one plug may comprise a metal, such as aluminum. In this case, a sealing tape may be adhered to an outer surface of the housing to cover the at least one plug.

With the configuration of the present invention, the distribution of air pressure around the disk is more uniformly formed in the circumference direction of the disk, thereby reducing the flutter of the disk.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating one example of a conventional hard disk drive;

FIGS. 2A and 2B illustrate simulation results on a speed of air flow within a conventional hard disk drive formed with a clock-head receiving hole on a side wall of a base member;

FIGS. 3A and 3B illustrate simulation results on a distribution of air pressure within a conventional hard disk drive;

FIG. 4 is an exploded perspective view illustrating a hard disk drive having a housing according to an embodiment of the present invention;

FIG. 5 is a perspective view illustrating a bottom of a base member in FIG. 4;

FIG. 6 is a cross-sectional view illustrating the base member taken along a line A-A′ in FIG. 4;

FIG. 7 is a partially cross-sectional view illustrating a base member of a hard disk drive according to another embodiment of the present invention;

FIG. 8 is a partially cross-sectional view illustrating a base member of a hard disk drive according to still another embodiment of the present invention; and

FIGS. 9A and 9B illustrate simulation results on a distribution of air pressure within the housing of a hard disk drive according to an embodiment of the present invention.

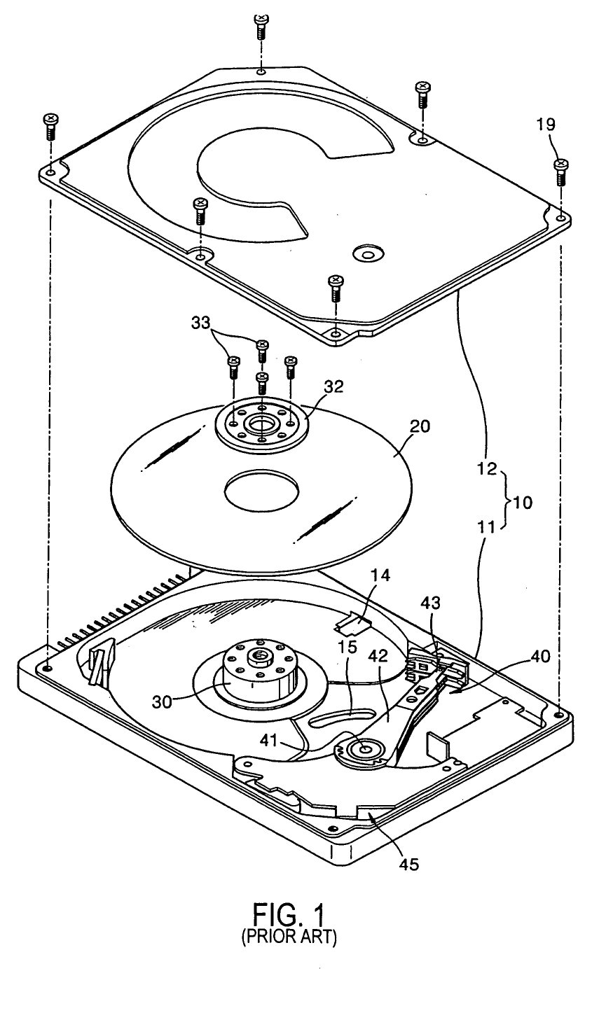

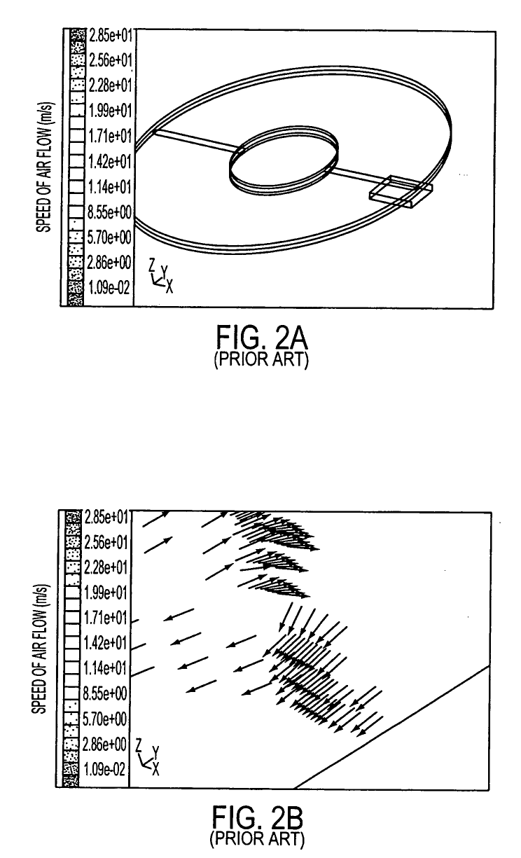

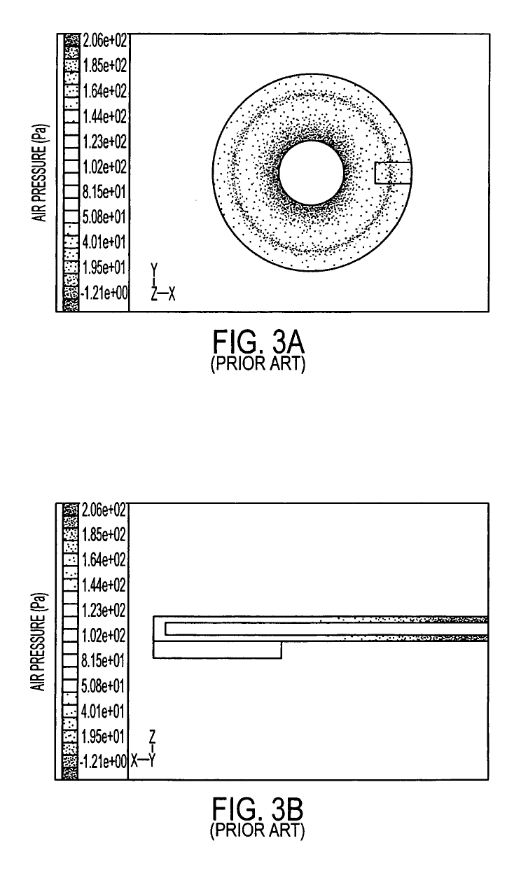

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

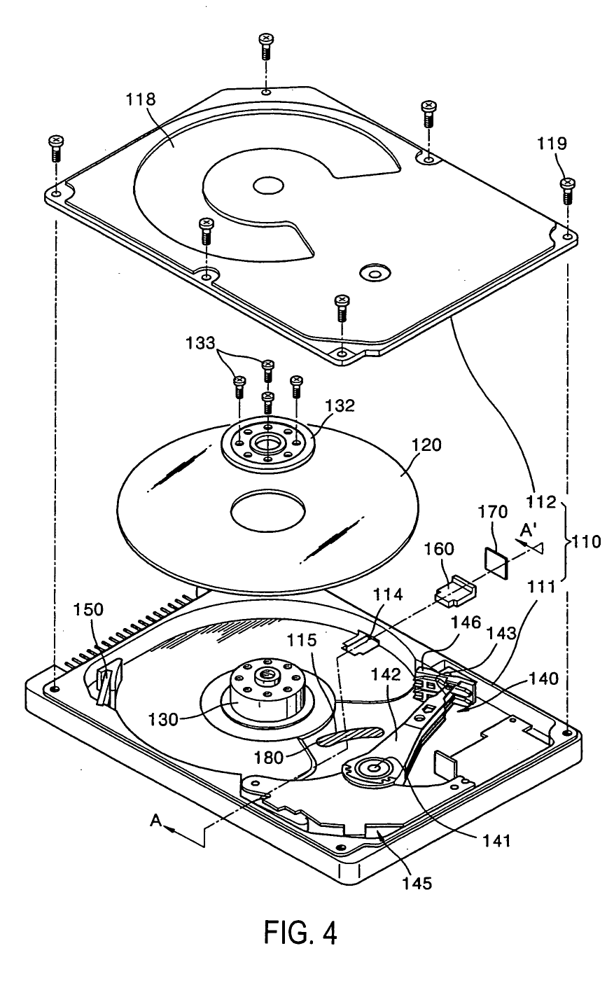

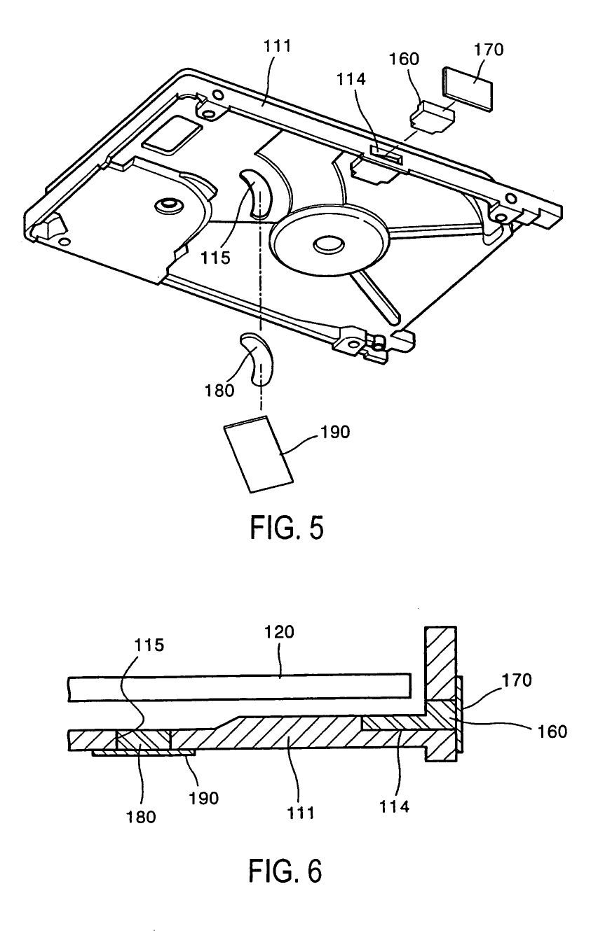

FIG. 4 is an exploded perspective view illustrating a hard disk drive having a housing according to an embodiment of the present invention. FIG. 5 is a perspective view illustrating a bottom of a base member in FIG. 4. FIG. 6 is a cross-sectional view illustrating the base member taken along a line A-A′ in FIG. 4.

Referring to FIGS. 4 to 6, the hard disk drive is an apparatus to read data from a data storage disk 120 and/or to write the data on the disk 120. Such a hard disk drive includes a housing 110, and the disk 120, a spindle motor 130, and an actuator 140 disposed in the housing 110.

The housing 110 encloses and protects the disk 120, the spindle motor 130, and the actuator 140, and includes a base member 111 and a cover member 112. The base member 111 is generally, though not necessarily, made of aluminum or aluminum alloy, and can be made in a bowl shape through die casting, as shown in FIG. 4. The cover member 112 may be made in a plate shape by pressing a plate of aluminum or stainless steel. The cover member 112 is coupled to an upper portion of the base member 111 by means of a plurality of screws 119 to protect the disk 120, the spindle motor 130, and the actuator 140, and thus prevents an inflow of dust or moisture into the housing 110 from the exterior. The cover member 112 may be formed with a groove 118 to reduce a spacing between the disk 120 and the cover member 112, in order to reduce flutter of the disk 120.

Alternatively, the base member 111 may be made in a plate shape, while the cover member 112 may be made in a bowl shape.

The spindle motor 130 is installed to the base member 111. The spindle motor 130 may be provided with at least one disk 120. The disk 120 is firmly secured to the spindle motor 130 by a clamp 132 and clamping screws 133, so that the disk 120 spins together with the spindle motor 130.

The actuator 140 includes a swing arm 142 rotatably coupled to a pivot bearing 141 coupled to the base member 111 to move a read/write head to a desired position on the disk 120, a suspension 143 provided at one end portion of the swing arm 142 to support and elastically bias a slider, on which the head is mounted, toward the surface of the disk 120, and a voice coil motor (VCM) 145 to rotate the swing arm 142. The voice coil motor 145 is controlled by a servo control system. The swing arm 142 is rotated in a direction according to the Fleming's left-hand rule by the interaction between an electric current input to a VCM coil and a magnetic field generated by magnets. Specifically, when the disk 120 starts spinning by turning the hard disk drive on, the voice coil motor 145 rotates the swing arm 142 in a counterclockwise direction to move the head to a desired position on a recording surface of the disk 120. When the disk 120 stops spinning by turning the hard disk drive off, the voice coil motor 145 rotates the swing arm 142 in a clockwise direction to move the head away from the disk 120. At this time, the head, having been moved away from the recording surface of the disk 120, is parked on a ramp 146 provided outside of the disk 120.

The base member 111 is provided at a corner thereof with a circulation filter 150 for filtering particles contained in the air flowing in the hard disk drive.

In the hard disk drive configured as described above, the housing 110 is provided with at least one through hole to record servo track information on a surface of the disk 120. Specifically, the base member 111 is provided on a side wall thereof with a clock-head receiving hole 114, through which a clock head to record the servo track information on the disk 120 is inserted into the housing 110. In addition, the base member 111 is provided on a bottom plate thereof with a push-pin receiving hole 115 so that a push pin may be inserted into the housing 110 to control the pivot of the actuator 140 when the servo track information is recorded on the disk 120.

Alternatively, in the case where the cover member 112 is made in a bowl shape, the clock-head receiving hole 114 may be formed on the side wall of the cover member 112. Also, the clock-head receiving hole 114 may be formed on the upper surface of the cover 112.

This embodiment of the present invention will now be described on the basis of the case in which the clock-head receiving hole 114 is formed on the side wall of the base 111, as shown in FIG. 4.

As described above, turbulence may result from the clock-head receiving hole 114 and the push-pin receiving hole 115 around the disk 120. A distribution of pressure around the disk 120 is not uniform due to the turbulence, thereby causing flutter of the disk 120.

In order to prevent the turbulence, the housing 110 of the hard disk drive according to this embodiment of the present invention includes first and second plugs 160 and 180 respectively inserted into the clock-head receiving hole 114 and the push-pin receiving hole 115. Preferably, though not necessarily, each surface of the first and second plugs 160 and 180 facing the interior of the housing 110 is flush with an inner surface of the base member 111. Accordingly, the inner surface of the base member 111, containing the surfaces of the first and second plugs 160 and 180, forms a smooth surface with the first and second plugs 160 and 180. The effect provided by the configuration as described above will now be described with reference to simulation results on a distribution of air pressure in the housing 110.

The first and second plugs 160 and 180 are formed so as to be air-tightly inserted into the clock-head receiving hole 114 and the push-pin receiving hole 115, respectively. In order to prevent the first and second plugs 160 and 180 from being released from the clock-head receiving hole 114 and the push-pin receiving hole 115 due to vibration or external shock, the first and second plugs 160 and 180 may be adhered to inner surfaces of the clock-head receiving hole 114 and the push-pin receiving hole 115 with an adhesive member.

The first and second plugs 160 and 180 may be made of plastic injection moldings or metal. For example, in the case in which the first and second plugs 160 and 180 are made of plastic injection moldings, there is an advantage in that the plugs 160 and 180 are more easily made. However, since the plastic injection moldings do not effectively shield an electromagnetic wave, first and second sealing tapes 170 and 190, which shield the electromagnetic waves, may be adhered to an outer surface of the side wall and an outer surface of the bottom plate of the base member 111 to cover the first and second plugs 160 and 180. An aluminum tape may be used as the first and second sealing tapes 170 and 190. The aluminum tape serves to shield transmission of the external electromagnetic waves to the interior of the housing 110 through the clock-head receiving hole 114 and the push-pin receiving hole 115, and also serves to decorate an appearance of the base member 111.

In the case in which the first and second plugs 160 and 180 are made of metal, the plugs themselves effectively shield the electromagnetic waves. Preferably, though not necessarily, the metal is aluminum, which is the same as that of the base member 111. In this case, the first and second sealing tapes 170 and 190 may be adhered to the outer surface of the base member 111 to cover the first and second plugs 160 and 180, thereby decorating the appearance of the base member 111. However, as the first and second plugs 160 and 180 formed of metal effectively shield the electromagnetic waves, it is not necessary to provide the first and second sealing tapes 170 and 190 as aluminum tape to shield the electromagnetic wave. Therefore, various adhesive tapes can be utilized.

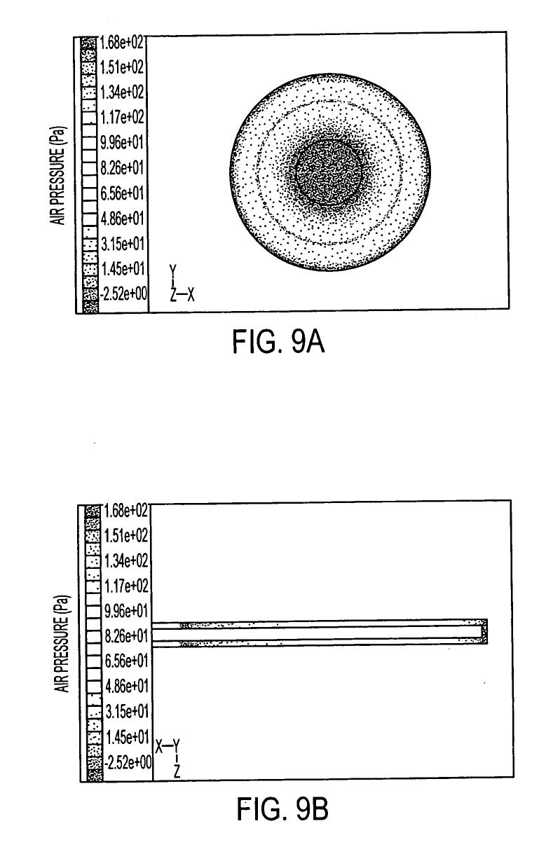

FIGS. 9A and 9B illustrate simulation results on a distribution of air pressure within a hard disk drive according to an embodiment of the present invention.

With the configuration of the present invention, since the clock-head receiving hole 114 and the push-pin receiving hole 115 are filled with the first and second plugs 160 and 180, the inner surface of the base member 111 forms a smooth surface together with the surfaces of the first and second plugs 160 and 180. As a result, there is no turbulence around the clock-head receiving hole 114 and the push-pin receiving hole 115. As such, the distribution of air pressure around the disk 120 is uniformly formed in the circumference direction of the disk 120. The uniform distribution of air pressure around the disk 120 may reduce the flutter of the disk 120.

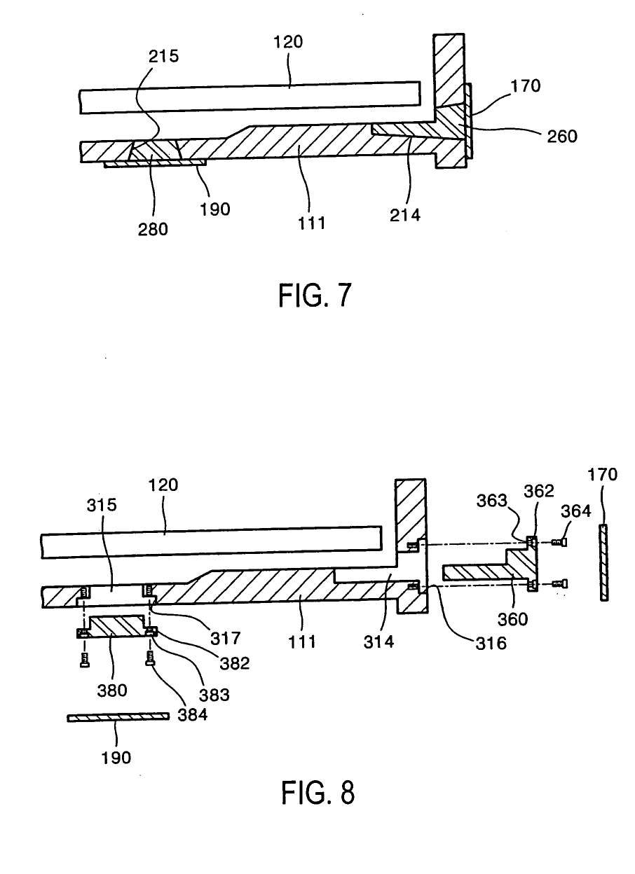

FIG. 7 is a partially cross-sectional view illustrating a base member of a hard disk drive according to another embodiment of the present invention.

Referring to FIG. 7, according to this embodiment of the present invention, a clock-head receiving hole 214 and a push-pin receiving hole 215 are formed in a taper shape of which a cross-sectional area is gradually increased toward the outer area of the base member 111. First and second plugs 260 and 280, inserted into the clock-head receiving hole 214 and the push-pin receiving hole 215, respectively, likewise have a taper shape corresponding to the shape of the clock-head and push-pin receiving holes 214 and 215.

With the above configuration, it is possible to prevent a potential problem in which the first and second plugs 260 and 280 slip into the housing 110 due to the vibration or external shock. In order to prevent the first and second plugs 260 and 280 from slipping out of the housing 110, first and second sealing tapes 170 and 190 are adhered to the outer surface of the base member 111 to cover the first and second plugs 260 and 280.

According to this embodiment of the present invention, the first and second plugs 260 and 280 may be adhered to inner surfaces of the clock-head receiving hole 214 and the push-pin receiving hole 215 with adhesive. In addition, the first and second plugs 260 and 280 may be made of plastic injection moldings or metal, of which a detailed configuration and effect thereof are similar to those of the embodiment previously described.

FIG. 8 is a partially cross-sectional view illustrating a base member of a hard disk drive according to still another embodiment of the present invention.

Referring to FIG. 8, according to this embodiment of the present invention, first and second plugs 360 and 380 are provided on outer end portions thereof with flanges 362 and 382. With the configuration, it is possible to prevent a problem in which the first and second plugs 360 and 380 slip into the housing 110 due to vibration or external shock. In order to prevent the first and second plugs 360 and 380 from slipping out of the housing 110, first and second sealing tapes 170 and 180 are adhered to the outer surface of the base member 111 to cover the first and second plugs 360 and 380.

Preferably, though not necessarily, the outer surface of the base member 111, i.e., the outer surface of the side wall and the outer surface of the bottom plate, is provided with stepped portions 316 and 317, which receive the flanges 362 and 382 of the first and second plugs 360 and 380, around a clock-head receiving hole 314 and a push-pin receiving hole 315, respectively. Accordingly, the flanges 362 and 382 of the first and second plugs 360 and 380 do not protrude from the outer surface of the base member 111, thereby providing the base member 111 with a good aesthetic appearance.

In addition, the first and second plugs 360 and 380 may be coupled to the base member 111 by means of coupling screws 364 and 384. To this end, the flanges 362 and 382 of the first and second plugs 360 and 380 are formed with screw receiving holes 363 and 383. With this configuration, the first and second plugs 360 and 380 are firmly secured to the base member 111, and the plugs 360 and 380 are not released from the clock-head receiving hole 314 and the push-pin receiving hole 315 due to vibration or external shock.

According to this embodiment of the present invention, the first and second plugs 360 and 380 may be adhered to inner surfaces of the clock-head receiving hole 314 and the push-pin receiving hole 315 with adhesive. In addition, the first and second plugs 360 and 380 may be made of plastic injection moldings or metal, of which a detailed configuration and effect thereof are similar to those of the embodiments previously described.

With the configuration of the present invention, the clock-head receiving hole and the push-pin receiving hole formed on the housing to be used in a servo track write operation are filled with the plugs, thereby suppressing production of turbulence around the holes. As such, the distribution of air pressure around the disk is uniformly formed in the circumference direction of the disk, thereby reducing the flutter of the disk.

Although a few embodiments of the present invention have been shown and described, it would be appreciated by those skilled in the art that changes may be made in these embodiments without departing from the principles and spirit of the invention, the scope of which is defined in the claims and their equivalents.

1. A housing for a hard disk drive including a data storage disk, a spindle motor to rotate the disk, and an actuator to move a read/write head to a desired position of the disk, the housing enclosing and protecting the disk, the spindle motor, and the actuator, and having a base member and a cover member, wherein:
the housing is provided with at least one through hole to record servo track information on the disk, and
at least one plug is inserted into the corresponding at least one through hole to fill the hole.

2. The housing as claimed in claim 1, wherein the at least one through hole comprises:
a clock-head receiving hole, through which a clock head is inserted to record the servo track information on the disk; and
a push-pin receiving hole, through which a push pin is inserted to control a pivot of the actuator.

3. The housing as claimed in claim 2, wherein the clock-head receiving hole is formed on a side wall of the base member, and the push-pin receiving hole is formed on a bottom plate of the base member.

4. The housing as claimed in claim 1, wherein a surface of the at least one plug facing an interior of the housing is flush with a corresponding inner surface of the base member.

5. The housing as claimed in claim 1, wherein the at least one through hole is formed in a taper shape of which a cross-sectional area is gradually increased approaching an outside of the base member, and wherein the corresponding at least one plug is formed in a taper shape corresponding to that of the at least one through hole.

6. The housing as claimed in claim 1, wherein the at least one plug is provided with a flange on an outer end portion thereof.

7. The housing as claimed in claim 6, wherein an outer surface of the housing is formed with a stepped portion around the at least one through hole to receive the flange of the corresponding at least one plug.

8. The housing as claimed in claim 6, wherein the at least one plug is coupled to the housing with at least one screw.

9. The housing as claimed in claim 1, wherein the at least one plug is adhered to the housing with an adhesive.

10. The housing as claimed in claim 1, Wherein the at least one plug comprises a plastic injection molding, and a sealing tape to shield an electromagnetic wave is adhered to an outer surface of the housing to cover the at least one plug.

11. The housing as claimed in claim 10, wherein the sealing tape is an aluminum tape.

12. The housing as claimed in claim 1, wherein the at least one plug comprises a metal.

13. The housing as claimed in claim 12, wherein the metal is aluminum.

14. The housing as claimed in claim 12, wherein a sealing tape is adhered to an outer surface of the housing to cover the at least one plug.

15. The housing as claimed in claim 8, wherein an adhesive member is provided on an outer surface of the at least one plug to provide a smooth surface.

16. The housing as claimed in claim 1, wherein the at least one plug provides an airtight seal in the corresponding at least one through hole.

17. The housing as claimed in claim 1, wherein the base member is provided in a bowl shape, the cover member is provided in a plate shape, and the at least one through hole is provided in the base member.

18. The housing as claimed in claim 1, wherein the cover member is provided in a bowl shape, the base member is provided in a plate shape, and the at least one through hole is provided in the cover member.

19. A hard disk drive assembly, comprising:
a housing to enclose the hard disk drive;
at least one through hole provided in the housing to record data to a disk of the hard disk drive; and
at least one removably installed plug provided in the corresponding at least one through hole to prevent air flow through the corresponding at least one through hole.

20. A plug formed to be provided in a through hole of a housing of a hard disk drive, wherein:
the plug is removably installed in the housing; and
the plug prevents an airflow through the through hole;
wherein an inner portion of the plug forms a smooth surface with an inner surface of the housing.

21. The plug as claimed in claim 20, wherein the through hole is used to write data to the hard disk drive.

22. The plug as claimed in claim 20, wherein the through hole is a clock-head receiving hole or a push-pin receiving hole.

23. The plug as claimed in claim 20, wherein the plug is adhered to the housing with an adhesive member.

24. The plug as claimed in claim 23, wherein the adhesive member shields an electromagnetic wave.

25. The plug as claimed in claim 20, wherein the through hole is formed in a taper shape of which a cross-sectional area increases approaching an outer surface of the housing, and wherein the plug is formed in a shape corresponding to the through hole.

26. The plug as claimed in claim 20, wherein the plug is provided with a flange on an outer end portion thereof.

27. The plug as claimed in claim 26, wherein the flange is formed so as to be disposed in a stepped portion of the housing around the through hole.

28. The plug as claimed in claim 26, wherein the plug is coupled to the housing with a screw.
